(19) United States
(12) Patent Application Publication
(10) Pub. No.: US 2026/0161503 A1
(43) Pub. Date: Jun. 11, 2026

(54) MEMORY DEVICE AND METHOD OF OPERATING A MEMORY DEVICE

(71) Applicant: Infineon Technologies AG, Neubiberg (DE)

(72) Inventors: Akshaya Prashanthi Lakshmi Narayanan, München (DE); George Alkhoury, München (DE)

(21) Appl. No.: 19/302,216

(22) Filed: Aug. 18, 2025

(30) Foreign Application Priority Data
Aug. 22, 2024 (DE) 102024124066.0

(51) Int. Cl. G06F 11/10

(52) U.S. Cl. CPC G06F 11/1044

(57) ABSTRACT

A memory device is provided. The memory device includes: a plurality of memory elements, wherein each of the plurality of memory elements is configured to store a data value, and a controller configured to read a plurality of stored data values from the plurality of memory elements, process the stored data values using an error detection code, thereby generating a first erasure vector, to map an address list of permanently dysfunctional memory elements generated during initial testing of the memory device onto the plurality of memory elements, thereby generating a second erasure vector; and to process the plurality of stored data values using an error correction code taking into account the first erasure vector and the second erasure vector.

### REFERENCE TO RELATED APPLICATION

This application claims priority to German Application number 102024124066.0, Aug. 22, 2024, the contents of which are hereby incorporated by reference in their entirety.

### TECHNICAL FIELD

Various embodiments relate generally to a memory device and to a method of operating a memory device.

### BACKGROUND

A memory array may possibly have any, some, or all of the following kinds of defects after production: bitgroup fails, wordline oriented fails, and single cell fails.

Memory devices with defective bitlines are either not repaired, which may lead to a yield loss of about 6%, or where redundant bit groups are provided for storing data that are meant to be stored in bit groups that include the defective bitlines. The latter treatment may lower the yield loss to less than about 0.1%, but the redundant bit groups may lead to an overhead in required area. An amount of the overhead may depend on a data transformation scheme (e.g., whether a 6/8-scheme or a 7/8-scheme is used, in other words, whether 6 or 7 bits of user data are transformed into 8 bits of stored data), but may be in a range of about 2% to 2.5%.

### SUMMARY

A memory device is provided. The memory device includes: a plurality of memory elements, wherein each of the plurality of memory elements is configured to store a data value, and a controller configured to read a plurality of stored data values from the plurality of memory elements, process the stored data values using an error detection code, thereby generating a first erasure vector, to map an address list of permanently dysfunctional memory elements generated during initial testing of the memory device onto the plurality of memory elements, thereby generating a second erasure vector; and to process the plurality of stored data values using an error correction code taking into account the first erasure vector and the second erasure vector.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 schematically illustrates a memory device with an array of memory cells;

FIGS. 2A and 2B schematically illustrate a bitline repair;

FIG. 3 schematically illustrates a repair of faulty data stored in memory cells that are known to be defective in a memory device in accordance with various embodiments;

FIG. 4 schematically illustrates how various kinds of defects in a memory device of various embodiments are handled;

FIGS. 5A and 5B schematically illustrate details of a repair of faulty data stored in memory elements that are known to be permanently dysfunctional in a memory device in accordance with various embodiments; and

FIG. 6 shows a flow diagram of a method of operating a memory device in accordance with various embodiments.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various aspects of the disclosure are provided for devices, and various aspects of the disclosure are provided for methods. It will be understood that basic properties of the devices also hold for the methods and vice versa. Therefore, for sake of brevity, duplicate description of such properties may have been omitted.

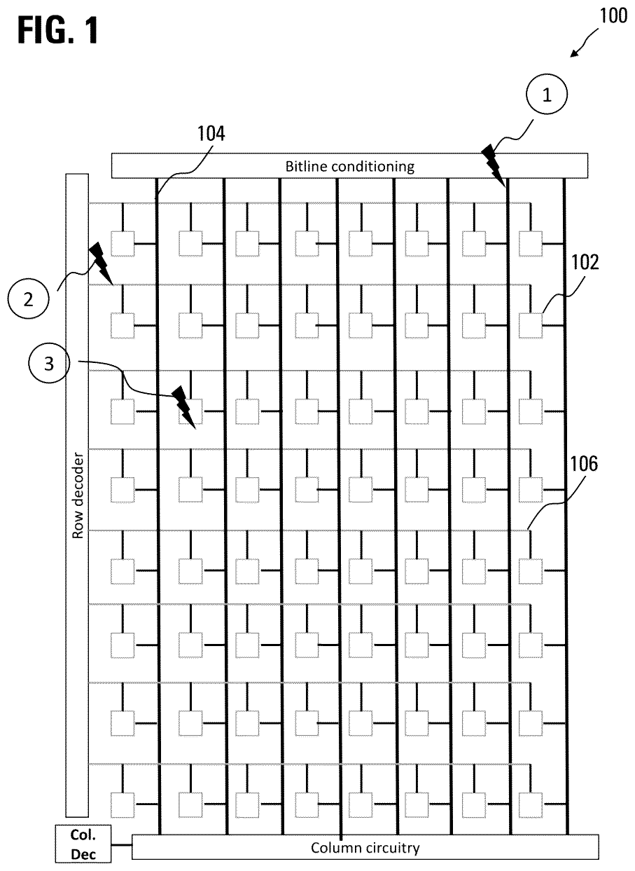

FIG. 1 visualizes schematically an array of memory cells 102 that may be part of a memory device 100.

A flash symbol labelled with “1” indicates the bitgroup fails. Here, the failure affects all the memory cells connected to a failing bitline 104, which runs vertically in FIG. 1. A flash symbol labelled with “2” indicates the wordline 106 oriented fails. Here, the failure affects all the memory cells along a wordline 106, which runs horizontally in FIG. 1. A flash symbol labelled with “3” indicates the single cell 102 fail. In all cases, a “failing” memory cell (irrespective of whether it fails individually or as part of a bitline failure or part of a wordline failure) may be permanently “stuck” in one of its possible programming states, e.g., either in a “1” state or in a “0” state.

All these defects may reduce a yield of the memory device production, unless they are repaired.

Single defects and wordline oriented defects may for example be repaired with a classic wordline redundancy mechanism.

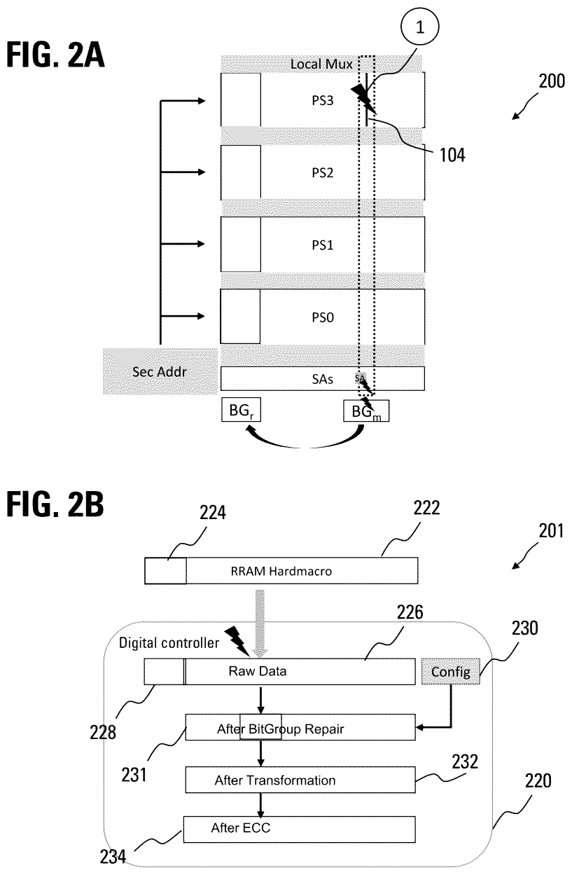

The bitgroup fails, however, are more expensive to be repaired with redundancy. The repair may need to address a whole bitgroup (the bitgroup may for example include eight bits (a byte)). For this repair, as illustrated in FIG. 2A, which illustrates elements of a memory device 200, and FIG. 2B, which illustrates data and data handling in the memory device 201. a sense amplifier SA circuitry may be expanded. Additional/redundant bit groups BGᵣ may be provided in the non-volatile memory (NVM) hardmacro, which are meant to be used as “backup” in case of a failing bitline 104 that affects a whole column of bit groups BGₘ. Even though the terms “additional bit groups” and “redundant bit groups” are used somewhat interchangeably herein, the term “additional” stresses the aspect that the memory elements are provided in case they may be required, and the term “redundant” stresses the aspect that the additional/redundant memory cells store, redundantly, certain data that were intended to be stored in the memory elements that are affected by the faulty bitline 104.

As indicated in FIG. 2A, the additional bit groups BGᵣ may be provided with their own respective addresses (indicated as “Sec Addr” in FIG. 2A). When it is intended to read data 224 from a bit group BGₘ that is affected by the failing bitline 104 of the memory device 200, a digital controller 220 instructs to read the raw data 226 from the addressed memory portion 222 and to replace the faulty bit group BGₘ as indicated in a configuration file 230 by a data portion 228 from the additional bit groups BGᵣ, thereby forming a repaired bitgroup 231. Data processing like transformation 232 and error correction by an ECC 234 are performed on the repaired bitgroup 231.

This type of repair may come at the cost of a significant amount of additional area that is required, for example, because, per permanently dysfunctional memory element 102, a whole group of memory elements (e.g., eight memory elements 102 in case of the group consisting of eight memory elements, a byte).

In various embodiments, a memory device is provided that has a yield loss of about 0.1%, but does not require additional area (in other words, the amount of overhead in required area may be zero).

In addition, using the redundant bit groups BGᵣ, the bit group redundancy repair may be considered to be “always on”. In other words, during every read from the memory device 200, a check occurs to determine whether a portion of the data from the presently addressed memory range is to be replaced with the data from the redundant bit group BGᵣ. This may degrade a read performance (in general, and in particular if an additional read process is required).

In various embodiments, the redundant bit groups BGᵣ are omitted, such that no area overhead is to be provided. A processor that is used in a digital controller may be re-used with some adjustments regarding the programming.

In various embodiments, an error correcting code (ECC) may be used for a repair of bit groups that are affected by a failing bitline. The ECC may essentially be used, but it may be adjusted in accordance with various embodiments as described herein.

Since a (final) correction of the failing bitlines is, in accordance with various embodiments, performed together with the ECC correction, there is no degradation of the read performance.

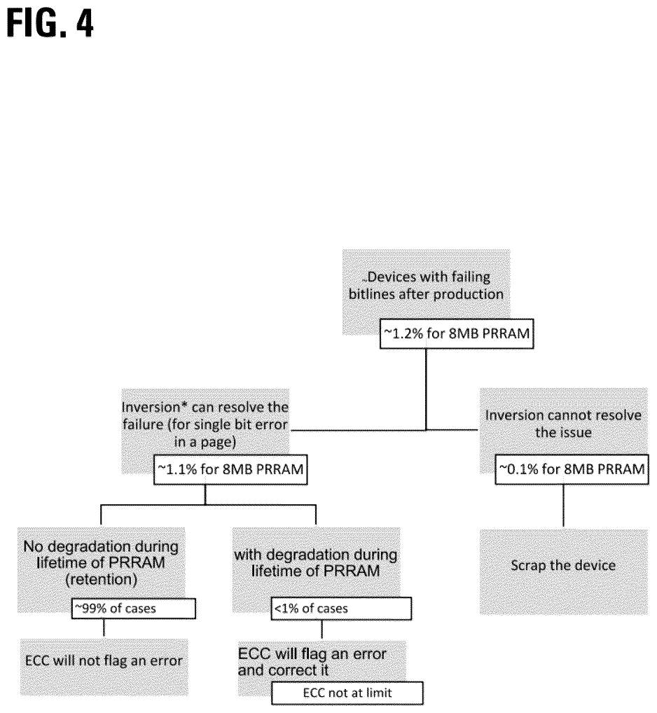

FIG. 4 illustrates, for an exemplary 8 MB Program Resistive Random Access Memory (PRRAM) device, why the herein described memory device (and method of operating it) achieve a high yield in combination with low (memory and/or semiconductor) area requirement.

Tests and simulations indicate that about 1.2% of exemplary 8 MB PPRAM devices may suffer failing bitlines after production.

For about 0.1% of the memory devices, an inversion of the stored data may not be able to resolve the issue. Such devices may for example include more than one failing bit per page. These devices may be discarded, causing the yield loss of about 0.1% (see right branch in FIG. 4).

In the remaining approximately 1.1% of the devices, data inversion may be able to resolve the failure, for example because each page includes only a single failing memory cell. Inversion will be discussed in more detail below.

Of these 1.1%, about 99% or more may suffer no degradation during its lifetime, which means that no error will be flagged by the ECC or an error detection code EDC (see leftmost branch in FIG. 4).

Less than about 0.1% of the memory devices may suffer degradation during its lifetime, which means that the ECC/EDC may flag an error and correct it. Most likely, the flagged error may be a single error, which means that the ECC is likely to not be driven to its limits.

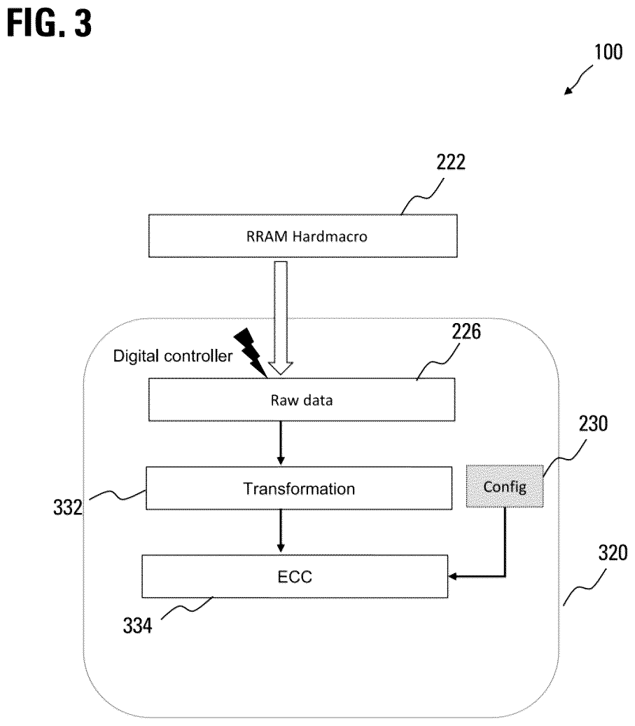

In various embodiments, a memory device 100 may include a processor 320 that may be configured to execute, initiate and/or control various functions of the memory device 100. In FIG. 3, a digital controller is specified as an example of a processor 320, but any kind of (e.g., micro-) processor 320 that is suitable of providing the herein specified functionality may be used.

In accordance with the various embodiments (aspects) described in this disclosure, a memory device (e.g., memory device 100, or other memory) and/or digital controller (e.g., controller 220, 320 or the other (micro) controller) is configured or implemented as an integrated circuit. This integrated circuit may include a silicon substrate with transistors disposed in the substrate with a metal interconnect structure over the substrate. The metal interconnect structure may include metal lines that are different heights over the substrate and vias that extend vertically between the metal lines, for example, coupling the transistors together to form circuitry of the memory device. The memory device 100 may be configured to process, perform or generate various aspects or embodiments disclosed herein via this circuitry with or without software, including executable instructions for such operations that are processed by the circuitry.

The memory device 100 may further include a plurality of memory elements 102, also referred to as memory cells (or “cells” or “elements” for short), (at least some of) which may be affected by bitline failures, wordline failures and/or single element/cell failures. The memory elements 102 may be non-volatile memory elements, for example resistive memory elements. The plurality of memory elements 102 may be part of the memory device 100 hardware, also referred to as hard macro 222. The memory device hardware may for example include, beside the memory elements 102, source amplifiers SA, conductive lines, multiplexers, address decoders, etc., essentially as known in the art.

In various embodiments, failing bitlines (and also failing wordlines and failing single memory elements) may be detected after production during product testing and may thus be considered as “pre-detected”.

The memory device 100 may be organized, e.g., for read- and/or write and/or error detection and/or error correction processes, in groups of memory elements 102. Each group of memory elements 102 may for example include eight memory elements for storing one byte (eight bits) of data, or a different number of two or more memory elements 102.

The groups of memory elements 102 may typically be organized along wordlines 106. This may lead to a situation in which each memory element 102 that is connected to a failing bitline 104 may be part of a (different) group of memory elements 102.

In the example shown in FIG. 1, which shows just a small fraction of a typical memory device 100 in accordance with various embodiments, eight memory elements 102 along a wordline 106 (row) may form one group of memory elements 102, thus FIG. 1 shows eight groups of memory elements 102 in total (one per row). The failing bitline 104 indicated by “1” may cause one permanently dysfunctional memory cell 102 per group of memory elements. In other words, all memory groups shown in FIG. 1 are affected by at least one permanently dysfunctional memory element 102. The group of memory elements in the second line are additionally affected by the wordline failure indicated by “2”, and the second memory element 102 of the group of memory elements in the third row is further affected by a single cell failure indicated by “3”.

The pre-detected failing memory elements 102 may be stored in a suitable way, for example as a (e.g., configuration) file or in a data base.

In various embodiments, the information on permanently dysfunctional memory elements 102 that are stored as part of the configuration may be augmented if new permanently dysfunctional memory elements 102 are discovered during a lifetime of the memory device 100. In various embodiments, if new permanently dysfunctional memory elements 102 are discovered during a lifetime of the memory device 100, the information may be stored as supplementary information, for example in an additional file or database. In that case, an identification of the known permanently dysfunctional memory elements 102 may be retrieved from a combination of both, the original information and the supplementary information.

Knowing a priori the positions of failing memory elements 102 and the organizational structure of the memory elements 102 means that the bit groups (e.g., eight-memory-element-groups, each of which configured to store one byte of data) affected by the permanently dysfunctional memory elements 102 may also be determined. Each group of memory elements 102 that includes a permanently dysfunctional memory element 102 may be identified as potentially faulty.

The plurality of memory elements 102 or a pre-defined subset of the plurality of memory elements 102, for example a subset referred to as a “page” (each page may include a plurality of groups of memory elements 102, wherein the memory elements 102 may be arranged as an array or as a matrix along a plurality of bitlines 104 and along a plurality of wordlines 106), may be labelled as belonging to a group of memory elements 102 that contains one or more potentially faulty memory elements 102, or to a group of memory elements 102 that contains no a priori known permanently faulty memory element 102. The labelling may for example be provided as a so-called erasure vector, which may include one data value for each group of memory elements (of the memory device 100 or of the pre-defined subset; in other words, the erasure vector may have as many elements/values as the memory device or the pre-defined subset has groups of memory elements 102). The data value of the erasure vector may be set to a first value (e.g., “1”) for a bit group that includes at least one permanently dysfunctional memory element 102, and to a second value (e.g., “0”), which is different from the first value, for a bit group that is free from permanently dysfunctional memory elements 102. This erasure vector is referred to as second erasure vector vec₂, to differentiate it from another (first) erasure vector vec₁ to be described below.

The second erasure vector vec₂ may in various embodiments be created “on the fly” as part of a read process. As an alternative, the second erasure vector vec₂ may in various embodiments be pre-created and stored, e.g., as a file or in a database.

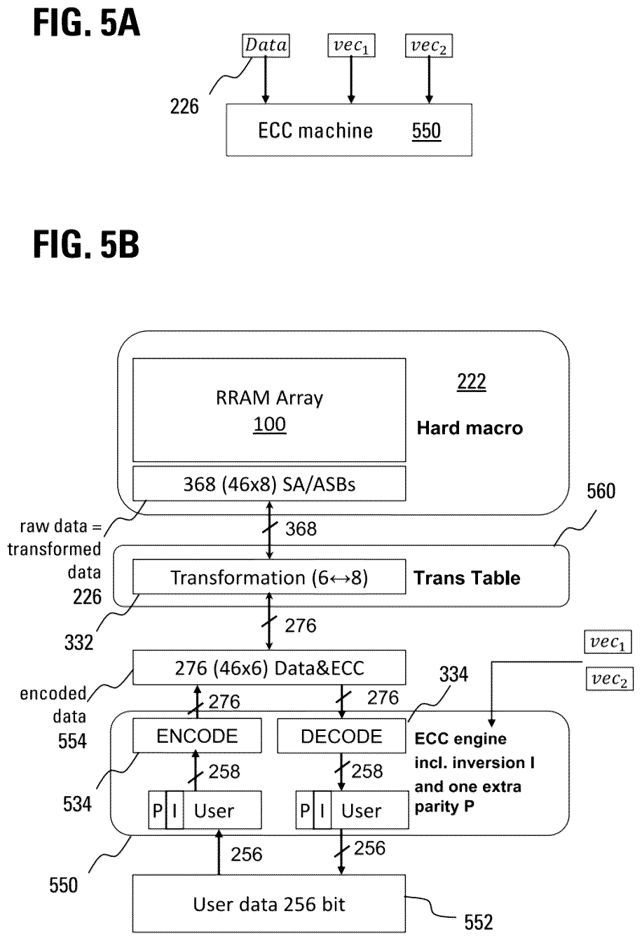

FIGS. 5A and 5B schematically illustrate details of a repair of (potentially) faulty data stored in memory elements that are known to be permanently dysfunctional in a memory device 100 in accordance with various embodiments.

The second erasure vector vec₂ may in various embodiments be provided to a code that performs an error correction (ECC, ECC engine 550). ECC engine 550 may be a processor, software or combination of hardware and software configured for receiving one or more erasure vectors and generating an ECC or error detection code for encoding and decoding operations. The ECC engine 550 can include input and output terminals with processing circuitry, including one or more transistors in communication with, or communicatively coupled to, a memory device (e.g., device 100) or controller (e.g., controller 220, 320).

With the second erasure vector vec₂ provided as input to the ECC 550, a detection capability of the ECC 550 (or rather, of its corresponding error detection code EDC, which is considered to be provided as part of the ECC 550) is not required for detecting groups of memory elements 102 containing previously known permanently dysfunctional memory elements 102. Thus, provision of the second erasure vector vec₂ may save error detection power.

Also error correction power may in various embodiments be saved by one, some, or all of the following aspects.

In various embodiments, a correction of data 226 stored in a group of memory elements 102 for which the second erasure vector vec₂ indicates (e.g., by having the first value, e.g., 1) that the group of memory elements 102 includes a permanently dysfunctional memory element 102 (“pre-detected” as stated above) may be done only if all of the following conditions apply:
data inversion has not been successfully applied (i.e., corrected the data word) during write access;
data transformation 332 (a pre-process to ECC processing that may use a pre-defined transformation pattern for transforming a predefined number (e.g., 6 or 7) of data values to a predefined larger number (e.g., 8) of transformed data values) has not already corrected the data, wherein the transformation process may in principle be known in the art;
written data are not already a valid/expected codeword (ECC processing may include an encoding process 534 during a write access to the memory elements 102 and a decoding process 334, which corresponds to an inverse process, during a read access to the memory elements 102; as part of the write process, the written data may be read back and it may be verified that the data read from the group of memory elements 102 form a codeword of the code, thus having been written error-free, possibly despite the permanently dysfunctional memory element 102, which may have been stuck at a favourable data value for the data that were written.

Permanently dysfunctional memory elements 102 caused by a defective wordline may, essentially as known in the art, be repaired by storing redundant data in a different wordline, but this mechanism has either not been applied or it has failed.

In various embodiments, as mentioned above, further input to the ECC 550 may be provided. This is indicated in FIGS. 5A and 5B, besides the data 226 and the second erasure vector vec₂, by the first erasure vector vec₁.

The first erasure vector vec₁ may be provided by the ECC, more specifically, by the decoder (the EDC) that recognizes, during a verification read as part of the write process, that the read data do not form a codeword of the ECC.

As outlined above, each of the first erasure vector vec₁ and the second erasure vector vec₂ may have the same length as the number of groups of memory elements that have been addressed for the reading from the memory (the data stored in the groups of memory elements may be referred to as bit groups, for example bytes in the case of eight bits).

For the first erasure vector vec₁, the values may follow the same scheme as described above for the second erasure vector vec₂: A first value (e.g., “1”) may indicate that the respective bit group has at least one error (resulting from the known permanently dysfunctional memory element 102 or from a different source of error), and a second value (e.g., “0”) may indicate that the respective bit group forms a codeword of the ECC and is thus considered to be error-free.

In other words, every position in an erasure vector (the first erasure vector vec₁ and the second erasure vector vec₂) marks if the according byte is erroneous (first value, e.g. “1”) or not (second value, e.g. “0”).

Both erasure vectors, the first erasure vector vec₁ and the second erasure vector vec₂, may in various embodiments be taken into account when applying the correction.

In various embodiments, the two erasure vectors, the first erasure vector vec₁ and the second erasure vector vec₂, may be added together, for example through OR gates. Thus, even if the two vectors, the first erasure vector vec₁ and the second erasure vector vec₂, have an error at the same position, the resulting (final) erasure vector, which may serve as a basis for deciding whether to use the ECC for correcting a given bit group, may still indicate an error at that position (and thus trigger a correction).

Today, the ECC can typically correct 1 Byte error and 2 erasures (erasures are located errors, the position is known but not the value). And since, in various embodiments, the position of the failing bitline is known, it can be treated as an erasure (otherwise there would be a danger that the ECC may interpret the failing bitline as a byte error and reach its limit).

Final erasure vector=vec₁+vec₂

If it is desired to, for example, exclude bit groups from correction that are indicated, in the first erasure vector vec₁, as being error-free, vec₁ and vec₂ may be taken into account in other ways than outlined above, for example individually, or the final erasure vector may be formed differently, e.g. using other suitable logic combinations.

As briefly mentioned above, the embodiments may save memory/semiconductor/chip area in the hardmacro by correcting failing bitlines using the already existing ECC instead of using redundant bit groups (which may even possibly fail themselves).

As another aspect, an existing functionality may be re-used: The failing bitline (or rather, the respective bit group that includes the possibly faulty bit that would have been stored in the failing bitline) may be provided to the ECC as an erasure, which may be corrected along with the other erasures coming from the decoder, e.g., the ECC.

As another aspect, a correction may only be conducted when it is required (or when it makes sense at all). For example, a bit group that includes a permanently dysfunctional memory element may not be corrected if inversion took care of the correction already (this functionality is already available and rarely used).

Another reason for not attempting an ECC correction is if the data word is already uncorrectable even without the “pre-detected” failing bit group.

As can be seen in FIG. 5B, ECC encoding is performed on user data 552 (as part of a write process). Correspondingly, decoding, in the ECC, read and processed stored data may result in the user data 552 (provided they are correctly read and/or restored).

Inversion bits I and parity bits P may be added by and processed in the ECC engine 550. The inversion bit indicates whether the user data is stored non-inverted or inverted. In case the user data is stored inverted, every 0 in the user data represented as a 1 and every 1 represented as a zero. During writing, the user data can be stored either inverted or not inverted. For example, if a single bit of the RRAM array is a stuck bit that permanently reads “1”, the user data can be stored either inverted or not inverted, whichever option ensures that the stuck bit should have the value “1” and not “0”. In this way, it is possible to cope with some single bit errors in the RRAM array 100 without requiring the use of the ECC to correct errors on reading. In this case, the ECC may be used to correct errors that occur after writing.

A transformation table 560 that defines how the encoded data 554 are to be transformed to form the to-be-written raw data, and how, conversely, the raw data are to be un-transformed to re-generate the encoded data 554, may be part of a digital interface of the memory device 100.

As mentioned above, even additional errors occurring during a lifetime of the memory device are likely to not drive the ECC 550 to its limits, since a typically used ECC 550 for a memory as described herein may be capable of correcting one erasure, one (additional, later-occurring) byte error, or two erasures. Thus, even if another erasure occurs, the ECC 550 is likely to still be able to correct the bit group.

A likelihood of a byte error occurring is much smaller than a likelihood of an erasure, with a relative rate of about 1 to 1000.

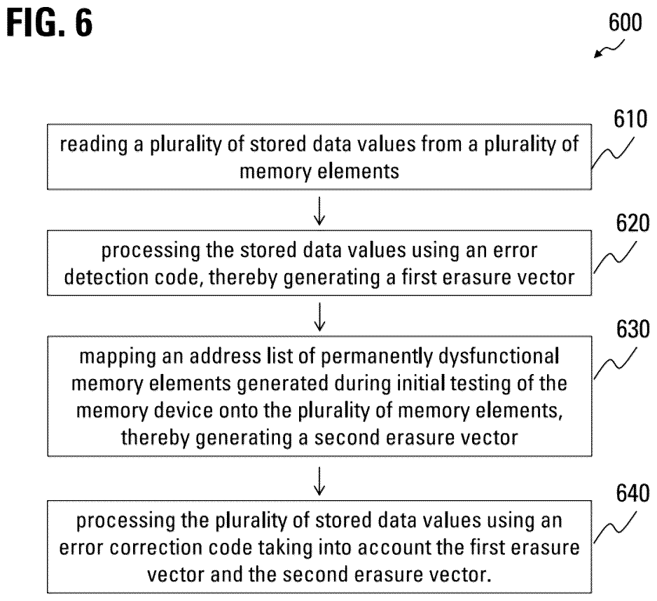

FIG. 6 shows a flow diagram 600 of a method of operating a memory device in accordance with various embodiments. The memory device may include a plurality of memory elements, wherein each of the plurality of memory elements may be configured to store a data value.

The method may include reading a plurality of stored data values from the plurality of memory elements (610), processing the stored data values using an error detection code, thereby generating a first erasure vector (620), mapping an address list of permanently dysfunctional memory elements generated during initial testing of the memory device onto the plurality of memory elements, thereby generating a second erasure vector (630), and processing the plurality of stored data values using an error correction code taking into account the first erasure vector and the second erasure vector (640).

Various examples will be illustrated in the following:

Example 1 is a memory device. The memory device includes: a plurality of memory elements, wherein each of the plurality of memory elements is configured to store a data value, and a controller configured to read a plurality of stored data values from the plurality of memory elements, process the stored data values using an error detection code, thereby generating a first erasure vector, to map an address list of permanently dysfunctional memory elements generated during initial testing of the memory device onto the plurality of memory elements, thereby generating a second erasure vector; and to process the plurality of stored data values using an error correction code taking into account the first erasure vector and the second erasure vector.

In Example 2, the subject-matter of Example 1 may optionally include that the plurality of memory elements is logically divided into groups of memory elements, and that the first erasure vector includes, for each of the groups of memory elements, a first value if the processing using the error detection code results in an error within the respective group, and a second value if the processing using the error detection code results in no error within the respective group.

In Example 3, the subject-matter of Example 1 or 2 may optionally include that the plurality of memory elements is logically divided into groups of memory elements, and that the second erasure vector comprises, for each of the groups of memory elements, a first value if the respective group contains a permanently dysfunctional memory element, and a second value if the respective group is free from permanently dysfunctional memory elements.

In Example 4, the subject-matter of any of Examples 1 to 3 may optionally include that the taking into account the first erasure vector and the second erasure vector includes applying a logic OR operation on the first erasure vector and the second erasure vector.

In Example 5, the subject-matter of any of Examples 1 to 4 may optionally include that the processing the plurality of stored data values using an error correction code taking into account the first erasure vector and the second erasure vector comprises applying an error correction if the first erasure vector indicates an error detected by the error detection code, and if, additionally or exclusively, the second erasure vector indicates a permanently dysfunctional memory element.

In Example 6, the subject-matter of any of Examples 1 to 5 may optionally include that the processor is further configured to process user data, and to write the processed user data to the plurality of memory elements to form the plurality of stored data values, wherein the processing includes error correction encoding the user data, thereby forming encoded data.

In Example 7, the subject-matter of Example 6 may optionally include that the processing further includes transforming the encoded data using a predefined transformation scheme to form transformed data.

In Example 8, the subject-matter of Example 6 or 7 may optionally include that the writing includes analyzing whether the written data are read error-free, and if the analyzing results in the written data being read with an error, re-writing the processed user data with all bits inverted, and setting a dedicated inversion bit to a predefined value indicative of the inversion of the data.

Example 9 is a method of operating a memory device that includes a plurality of memory elements, wherein each of the plurality of memory elements is configured to store a data value. The method includes reading a plurality of stored data values from the plurality of memory elements, processing the stored data values using an error detection code, thereby generating a first erasure vector, mapping an address list of permanently dysfunctional memory elements generated during initial testing of the memory device onto the plurality of memory elements, thereby generating a second erasure vector, and processing the plurality of stored data values using an error correction code taking into account the first erasure vector and the second erasure vector.

In Example 10, the subject matter of Example 9 may optionally further include that the plurality of memory elements is logically divided into groups of memory elements, wherein the first erasure vector includes, for each of the groups of memory elements, a first value if the processing using the error detection code results in an error within the respective group, and a second value if the processing using the error detection code results in no error within the respective group.

In Example 11, the subject matter of Example 9 or 10 may optionally further include that the plurality of memory elements is logically divided into groups of memory elements, that the second erasure vector includes, for each of the groups of memory elements, a first value if the respective group contains a permanently dysfunctional memory element, and a second value if the respective group is free from permanently dysfunctional memory elements.

In Example 12, the subject matter of any of Examples 9 to 11 may optionally further include that the taking into account the first erasure vector and the second erasure vector comprises applying a logic OR operation on the first erasure vector and the second erasure vector.

In Example 13, the subject matter of any of Examples 9 to 12 may optionally further include that the processing the plurality of stored data values using an error correction code taking into account the first erasure vector and the second erasure vector comprises applying an error correction if the first erasure vector indicates an error detected by the error detection code, and if, additionally or exclusively, the second erasure vector indicates a permanently dysfunctional memory element.

In Example 14, the subject matter of any of Examples 9 to 13 may optionally further include processing user data, and writing the processed user data to the plurality of memory elements to form the plurality of stored data values, wherein the processing includes error correction encoding the user data, thereby forming encoded data.

In Example 15, the subject matter of Example 14 may optionally further include that the processing further includes transforming the encoded data using a predefined transformation scheme to form transformed data.

In Example 16, the subject matter of Example 14 or 15 may optionally further include that the writing includes analyzing whether the written data are read error-free, and if the analyzing results in the written data being read with an error, re-writing the processed user data with all bits inverted, and setting a dedicated inversion bit to a predefined value indicative of the inversion of the data.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A memory device, comprising:
a plurality of memory elements, wherein each of the plurality of memory elements is configured to store a data value; and
a controller configured to:
read a plurality of stored data values from the plurality of memory elements;
process the stored data values using an error detection code, thereby generating a first erasure vector;
map an address list of permanently dysfunctional memory elements generated during initial testing of the memory device onto the plurality of memory elements, thereby generating a second erasure vector; and
process the plurality of stored data values using an error correction code taking into account the first erasure vector and the second erasure vector.

2. The memory device of claim 1, wherein the plurality of memory elements is logically divided into groups of memory elements, and wherein the first erasure vector comprises, for each of the groups of memory elements, a first value in response to processing using the error detection code resulting in an error within the respective group, and a second value in response to the processing using the error detection code resulting in no error within the respective group.

3. The memory device of claim 1, wherein the controller is configured to generate user data and an inversion bit using the error detection code, and further arranged to invert the user data in response to the inversion bit indicating that the user data is inverted, and not to invert the user data in response to the inversion bit indicating that the user data is not inverted.

4. The memory device of claim 1, wherein the plurality of memory elements is logically divided into groups of memory elements, wherein the second erasure vector comprises, for each of the groups of memory elements, a first value in response to the respective group containing a permanently dysfunctional memory element, and a second value in response to the respective group being free from permanently dysfunctional memory elements.

5. The memory device of claim 1, wherein the taking into account the first erasure vector and the second erasure vector comprises applying a logical OR operation on the first erasure vector and the second erasure vector.

6. The memory device of claim 1, wherein processing the plurality of stored data values using an error correction code taking into account the first erasure vector and the second erasure vector comprises applying an error correction in response to the first erasure vector indicating an error detected by the error detection code, and in response to, additionally or exclusively, the second erasure vector indicating a permanently dysfunctional memory element.

7. The memory device of claim 1, wherein the controller is further configured to:
process user data; and
write the user data to the plurality of memory elements to form the plurality of stored data values;
wherein processing the plurality of stored data values comprises error correction encoding the user data, thereby forming encoded data.

8. The memory device of claim 7, wherein the processing further comprises transforming the encoded data using a predefined transformation scheme to form transformed data.

9. The memory device of claim 7, wherein writing the user data comprises:
analyzing whether the user data processed and written are read error-free; and
in response to the analyzing resulting in the user data being read with an error, re-writing the processed user data with all bits inverted, and setting a dedicated inversion bit to a predefined value indicative of an inversion of the user data.

10. A method of operating a memory device that comprises a plurality of memory elements, wherein each of the plurality of memory elements is configured to store a data value, the method comprising:
reading a plurality of stored data values from the plurality of memory elements;
processing the stored data values using an error detection code, thereby generating a first erasure vector;
mapping an address list of permanently dysfunctional memory elements generated during initial testing of the memory device onto the plurality of memory elements, thereby generating a second erasure vector; and
processing the plurality of stored data values using an error correction code taking into account the first erasure vector and the second erasure vector.

11. The method of claim 10, wherein the plurality of memory elements is logically divided into groups of memory elements, wherein the first erasure vector comprises, for each of the groups of memory elements, a first value in response to the processing using the error detection code resulting in an error within the respective group, and a second value in response to the processing using the error detection code resulting in no error within the respective group.

12. The method of claim 10, further comprising:
generating user data and an inversion bit using the error detection code; and
inverting the user data in response to the inversion bit indicating that the user data is inverted, but not in response to the inversion bit indicating that the user data is not inverted.

13. The method of claim 10, wherein the plurality of memory elements is logically divided into groups of memory elements, and wherein the second erasure vector comprises, for each of the groups of memory elements, a first value in response to the respective group comprising a permanently dysfunctional memory element, and a second value in response to the respective group being free from permanently dysfunctional memory elements.

14. The method of claim 10, wherein the taking into account the first erasure vector and the second erasure vector comprises applying a logic OR operation on the first erasure vector and the second erasure vector.

15. The method of claim 10, wherein the processing the plurality of stored data values using an error correction code taking into account the first erasure vector and the second erasure vector comprises applying an error correction in response to the first erasure vector indicates an error detected by the error detection code, and in response to, additionally or exclusively, the second erasure vector indicates a permanently dysfunctional memory element.

16. The method of any of claim 10, further comprising:
processing user data; and
writing the user data to the plurality of memory elements to form the plurality of stored data values;
wherein the processing comprises error correction encoding the user data, thereby forming encoded data.

17. The method of claim 16, wherein the processing further comprises transforming the encoded data using a predefined transformation scheme to form transformed data.

18. The method of claim 16, wherein the writing comprises:
analyzing whether the user data processed and written are read error-free; and
in response to the analyzing resulting in the user data being read with an error, re-writing the processed user data with all bits inverted, and setting a dedicated inversion bit to a predefined value indicative of an inversion of the user data.

19. A system, comprising:
a plurality of memory elements, wherein each of the plurality of memory elements is configured to store a data value; and
a processor coupled to the plurality of memory elements, the processor configured to:
read a plurality of stored data values from the plurality of memory elements;
process the stored data values using an error detection code, thereby generating a first erasure vector;
map an address list of permanently dysfunctional memory elements generated during initial testing of a memory device onto the plurality of memory elements, thereby generating a second erasure vector; and
process the plurality of stored data values using an error correction code taking into account the first erasure vector and the second erasure vector.

20. The system of claim 19, wherein the plurality of memory elements is logically divided into groups of memory elements, and wherein the first erasure vector comprises, for each of the groups of memory elements, a first value in response to processing using the error detection code resulting in an error within the respective group, and a second value in response to the processing using the error detection code resulting in no error within the respective group.
